(19) United States
(12) Patent Application Publication
(10) Pub. No.: US 2015/0047962 A1
(43) Pub. Date: Feb. 19, 2015

(54) DEVICE AND METHOD FOR THE CATALYTIC DEPOLYMERIZATION OF MATERIAL CONTAINING HYDROCARBON

(71) Applicant: AXEL TRAUTMANN, Nümbrecht (DE)

(72) Inventor: Axel Trautmann, Numbrecht (DE)

(21) Appl. No.: 14/388,106

(22) PCT Filed: Mar. 26, 2013
(86) PCT No.: PCT/EP2013/000904

§ 371 Date: Sep. 25, 2014

(30) Foreign Application Priority Data
Mar. 26, 2012 (DE) 10 2012 005 942.6
May 31, 2012 (DE) 10 2012 010 763.3

(51) Int. Cl. C10G 1/02; B01J 8/10

(52) U.S. Cl. CPC C10G 1/02; B01J 8/10; B01J 2208/00858
USPC 201/19; 202/99

(57) ABSTRACT

In a device for the catalytic depolymerisation of material containing hydrocarbon, containing at least one container which can be filled with the material, at least one conveyor device having a device for introducing heat into the interior of the conveyor device and having at least one inlet opening and at least one outlet opening spaced apart therefrom are provided in the container, wherein the inlet opening is or can be disposed in the lower region of the container and the outlet opening is or can be disposed in the upper region of the container for circulating and heating the material to the evaporation temperature. In a method for the catalytic depolymerisation of hydrocarbon-containing material using at least one container which can be filled with the material, at least one carrier medium is filled into the container, the material is introduced into the carrier medium, the carrier medium comprising the material is set in a rotary motion, the material is circulated through a conveyor device having a device for introducing heat and is heated until said material is brought to evaporation temperature, the rising vapour is condensed and the distillate components are discharged as product.

### FIELD OF THE INVENTION

The invention relates to a device and a method for the catalytic depolymerization of material containing hydrocarbon, containing at least one container which can be filled with the material.

### BACKGROUND OF THE INVENTION

Methods and devices for catalytic depolymerization are known. In the case of catalytic depolymerization, materials containing hydrocarbon are cleaved, thus making it possible to recover diesel oil in particular. Catalysts are used as a type of ion exchanger and crack hydrocarbon chains of different length.

By way of example, EP 1 538 191 A1 discloses a device and a method for producing diesel oil from residual materials containing hydrocarbon in an oil circuit with solids separator and product distillation for the diesel product by energy input with pumps and agitators rotating in opposite directions with use of fully crystalized catalysts formed from potassium silicates, sodium silicates, calcium silicates and magnesium-aluminum silicates, wherein in all surfaces are cleaned continuously by the agitators. The device used to carry out the method contains a high-performance pump, an agitator rotating in opposite directions, a throttle control valve, a separation cyclone in the circuit and separation containers with heated discharge screws and also a distillation system at the two outputs of the device. The device disclosed in this prior art is thus structured in a rather complex manner.

A further device of complex structure, but which works on the basis of pyrolysis, is known from WO 2012/016633 A2, in which, in a system for producing fuels from biomass/plastics mixtures, comprising a silo for biomass and a silo for plastics, biomass and plastics coming therefrom are heated in a biomass screw heater and a plastics screw heater and are dried and/or liquefied and melted before they are supplied to a disperser, in which they are dispersed at 300-400° C. and are simultaneously heated so as to form a suspension. The suspension is immediately transferred into a reactor. The system comprises a number of reactors, as well as a vacuum evaporator, condensers, a phase separator, separators, a rectification column and a gas engine or a gas turbine. This system is also clearly structured in a rather complex manner.

### SUMMARY OF THE INVENTION

The object of the present invention is therefore to provide an even more effective method for the catalytic depolymerization of material containing hydrocarbon and also a more compact device for carrying out this method, wherein in particular a higher degree of efficacy than with the method disclosed in EP 1 538 191 A1 is to be made possible.

The object is achieved for a device for the catalytic depolymerization of material containing hydrocarbon, comprising: at least one container (1) which can be filled with the material, wherein at least one conveyor device having a device for introducing heat into the interior of the conveyor device and having at least one inlet opening and at least one outlet opening spaced apart therefrom are provided in the container, wherein the inlet opening is or can be disposed in the lower region of the container and the outlet opening is or can be disposed in the upper region of the container for circulating and heating the material to evaporation temperature. For a method for the catalytic depolymerization of material containing hydrocarbon using at least one container which can be filled with the material, wherein the object is achieved in that at least one carrier material is filled into the container, the material is introduced into the carrier medium, the carrier medium with the material is set in a rotary motion, the material is circulated through a conveyor device having a device for introducing heat and is heated until it is brought to evaporation temperature, the rising vapor is condensed and the distillate components are discharged as product. Developments of the invention are defined in the dependent claims.

A device and a method for the catalytic depolymerization of material containing hydrocarbon, in particular of residual materials, such as waste oil, a mixture of waste oil and other material, cellulose, sewage sludge, plastics, etc., are thus provided, by means of which a rapid introduction of heat into the material to be depolymerized and therefore a rapid evaporation is possible due to the circulation and simultaneous heating of the materials to be depolymerized in the conveyor device or through said conveyor device, and therefore a high degree of efficacy is also possible. In this context, it has proven to be particularly advantageous when the device for introducing heat is a device functioning on the basis of induction, in particular a medium-frequency inductor. This device is advantageously arranged between the inlet opening and the outlet opening of the conveyor device on the outer side thereof, such that an introduction of heat into the interior of the conveyor device and therefore a heating of the material conveyed through there is possible. The heating is performed up to temperatures of over approximately 300° C. advantageously below approximately 390° C., since a catalytic molecular shortening occurs in this temperature range. With the method, sodium-aluminum silicates can be used for example as catalyst and function in the manner of an ion exchanger. These catalysts crack hydrocarbon chains of different lengths. In order to avoid energy losses as far as possible and in order to minimize the introduction of heat for heating the material, it has proven to be advantageous to form the container as a high-temperature container provided with at least one heat-insulating insulation layer. At least the components used to supply the material and also to heat and circulate said material are further advantageously arranged within this container, such that heat losses can be avoided as far as possible.

It has also proven to be advantageous when the conveyor device comprises conveyor elements for conveying the material from the at least one inlet opening to the at least one outlet opening and elements that bear against the inner face of the wall of the conveyor device as a result of the effect of centrifugal force. The elements bearing against the inner face of the wall of the conveyor device under the action of centrifugal force can be formed for example in the form of blades. The conveyor elements may comprise conveyor paddles or may be formed in the form of paddle wheels, which are provided with such blades and/or at least one movable depositor made of cast material. When rotating the conveyor elements, the further elements bear against the inner face of the wall of the conveyor device and clean the inner face of the wall, such that a clogging of the conveyor device by material deposited on the inner face of the outer wall of said conveyor device is avoided and the heat transfer from the outer device for introducing heat into the material flowing through the conveyor device through the wall of the conveyor device into the material conveyed through there can be kept optimal.

It has also proven to be advantageous when the container tapers in a funnel-shaped manner in the upper region. Gases produced can thus be better removed from the container. In particular, at least one column for condensing and removing distillate of different specific weight can be provided in the upper region of the container or is connected thereto. Such a column can be formed for example as a bubble tray column. By means of such a column, a separation of the distillate in accordance with the specific weight thereof is possible particularly well. By way of example, oil, diesel and petrol can be separated from one another hereby as heavy, medium-weight and light distillate and can be removed individually from the device or the column.

In the first evaporation phase of the material, water vapor is formed. In order to reduce the explosion risk, a suction device is advantageously provided in the upper region of the container or is connected thereto and can remove the vapor produced during the heating of the material until said vapor exceeds a temperature at which it is ensured that no more water vapor is contained in the vapor. By way of example, the vapor can be suctioned off via the suction device up to a temperature of approximately 105° C. and condensed in a cooling device, such that the water created during this process can be removed separately from the container. In order to cool down the water vapor occurring in the first stage of the evaporation phase, a tube bundle cooler can be provided, for example.

By introducing the material into the carrier medium and not into the upper region of the container, that is to say the vapor zone, the costs for an additional lock device can be spared or at least reduced, which otherwise is intended to prevent an introduction of air or in particular oxygen into the vapor zone. In order to supply the material, an introduction element is advantageously used, which is suitable for introducing solid and liquid materials, for example a filling pipe. This can be provided at the end with a comminution device in order to post-comminute the introduced material. By way of example, an agitator provided with a disk at the end can be used for this purpose with a low housing gap, such that merely sufficiently comminuted material can pass into the carrier medium. This material mixes with the carrier medium, wherein this is assisted by setting the carrier medium together with the material in a rotary motion. In addition to the agitator, a further device for producing thorough mixing can also be provided, which in particular can be arranged centrally in the container and may comprise elements that for example are paddle-like and/or are formed in the manner of blades and thoroughly mix the carrier medium and material with a rotary motion.

In order to prevent material from settling on the floor of the container, a device for example in the form of a rotatably mounted floor scraper can be provided, which is arranged at a distance from the floor of the container. By way of example, the floor scraper may comprise wing elements, which can be continuously driven rotatably at a distance from the floor via a drive unit, such as a motor.

Furthermore, at least one conveyor device, in particular a screw conveyor, comprising at least one device for solids drying may advantageously be provided, in particular an inlet opening of the conveyor device can be arranged in the lower region of the container. Solids from the floor region of the container can thus be removed from the floor region of the container via the conveyor device arranged in particular obliquely with respect to the vertical axis of the container, liquid components can flow back into the container, and a remaining oil cake can be heated and removed from the conveyor device in dried form. A solids separator is thus provided, by means of which a separation of solids settled on the floor of the container and liquid components and a return of the liquid components into the interior of the container is possible. By way of example an indentation or groove may be provided in the container floor and the conveyor device may be arranged in said indentation or groove, such that the conveyor device is arranged in the deepest part of the container. The conveyor device can entrain the solids settling there and can convey said solids out from the container via the obliquely arranged part of the conveyor device, for example in the form of a riser pipe with internal conveyor screw. The liquid components adhering to the solid can flow back into the container through the part of the conveyor device arranged obliquely relative to the container. The remaining oil cake, that is to say the solids freed substantially of the liquid components, can be heated within the conveyor device, such that a dry residue or solid can exit and be removed at the end of the conveyor device through an outlet opening provided there.

It has also proven to be advantageous to use an induction heater to heat the material in the conveyor device used to evaporate the material, wherein the energy to cool the inductor can be used or is used with use of a heat exchanger to pre-heat the material. A particularly high degree of efficacy can be attained as a result, since the energy that is to be used to cool the inductor can be recovered by provision of the heat exchanger and therefore the heat produced during this process can be used to pre-heat the material located in the carrier medium.

This conveyor device, by means of which the material is to be circulated and in doing so largely heated, such that is evaporates, is arranged at a distance from the container floor, wherein in particular an arrangement perpendicular with respect to the container is provided relative to the container floor. The floor scraper already specified beforehand can be arranged between the container floor and inlet opening of the conveyor device in order to facilitate the suction of material and in order avoid, as far as possible, a clogging of the inlet opening on account of material settling on the floor of the container.

To increase the degree of efficacy of the device or system, the material mixture, in particular plus an added catalyst, can be conveyed, in particular pumped, at temperatures of approximately 100° C. or above, for example approximately 100-130° C., into a pressure container. The material mixture may advantageously remain in the pressure container for a predeterminable period of time, for example approximately 30 min, under a predefinable pressure for example of 30 bar. The material mixture is then advantageously conveyed back into the container, in particular pumped. This measure can be performed optionally, depending on the composition of the feedstock. This measure results in an improved unlinking of the hydrocarbons and also a quicker and more efficient mixing of the input components or material components with the catalyst. This also means a greater yield of finished products and a smaller proportion of residual materials.

More advantageously, at least one additive, in particular catalyst material, can be introduced into the carrier medium/material mixture in order to bind undesirable depolymerization products, in particular halogens, furans, etc. Solid components can thus be bound and transported upwardly with respect to the container. A skimming of these solid components is possible, as is a recycling of the catalyst, since this remains in the container. In the case of catalytic depolymerization of, for example, transformer oil or PVC-containing plastics, chlorine is produced, which for example may be bound with slaked lime. By introducing additives, it is possible to separate these undesirable depolymerization products without introducing oxygen into the system.

The device according to the invention and the method according to the invention have also proven to be particularly advantageous since the residual materials no longer have to be post-processed. Rather, these can be removed once dried. Since, in particular when pressurizing the produced vapor, the product component that can be obtained is greater than with known methods and devices and fewer residual materials are produced, the degree of efficacy of the device and of the method can also be considerably increased hereby compared with the known devices and methods. Furthermore, it has proven to be very advantageous that all components used for the catalytic depolymerization can be arranged in the same container, where they can remain together with the carrier medium and the input materials to be polymerized. The material to be depolymerized advantageously enters the carrier medium directly in the interior of the container, that is to say in the liquid region, such that, when the material is filled, vapor cannot pass undesirably from the vapor zone arranged advantageously in the cover region of the container to the outside. The structure of the device is thus compact and there is lower risk of penetration for example of oxygen into the system, which would increase the risk of explosion with the production for example of oil, diesel and petrol.

The device advantageously used to heat the medium to be depolymerized conveyed by the conveyor device and functioning on the basis of induction can also be used otherwise to heat medium, for example to heat service water, here that is to say a device for heating water as medium. The device here particularly preferably comprises an inductor or at least one induction device and a medium-frequency generator. The heat losses otherwise occurring, in particular with use of a gas heater for heating service water, can be significantly reduced by the use of an introduction of heat by induction with use of a medium-frequency generator. Here, a preferably insulated container with at least one heating circuit feed connection and at least one heating circuit return connection and with at least two service water connections is preferably provided. A heating pipe with at least one service water inlet opening and at least one service water outlet opening is arranged between the two service water connections and is heated by induction with the aid of the medium-frequency generator. The service water flowing through the heating pipe is heated over its path through the heating pipe by induction. Water or another heating medium is received in the container in a manner surrounding the heating pipe and is fed into the heating circuit or comes therefrom. At least one temperature sensor can be provided, which measures the water temperature in the container and thus provides a signal to switch on and also to switch off the medium-frequency generator or is switched on and off by this signal of the medium-frequency generator.

In order to enable a particularly effective and need-oriented use of the heat energy provided by the induction device, at least two pipes, in particular plastic pipes, arranged one inside the other can be provided around the induction device. The at least one inner pipe may be a stator pipe and the at least one outer pipe may be a rotor pipe. Both pipes can be provided with openings, in particular slits, in the outer lateral surface thereof. The lateral surface of the rotor pipe can be closed by rotation with respect to the stator pipe. With closed lateral surfaces of both pipes, the maximum heating capacity is conveyed to the service water within the heating pipe. If the pipes are opened and if the openings or slits in the lateral surface of the pipes are accordingly opened, the transfer of heat into the service water can be shut off, such that the complete heat energy passes into the heating medium or the heating water circuit. Instead of the provision of the at least two pipes mounted rotatably with respect to one another and provided with openings in the outer lateral surface, a closeable perforated sheet or another device enabling completer heat transfer into the service water in one position and fully preventing this in another position can also be provided.

The heating medium in the container can be used to cool the induction device.

By way of example, 300 l of water in the container can be heated comparatively quickly to 60 to 70° C. and, in contrast to gas heating, without waste gases. The degree of efficacy is more than 95%, and in particular the degree of efficacy with use of a 10 kW medium-frequency generator corresponds for example to that of an 18 kW gas heater, such that a more economic operation of a heater with use of a medium-frequency generator instead of, for example, gas as means for heating the water is possible. Exhaust gas pipes also are no longer necessary with use of induction energy, which is generated by a medium-frequency generator to heat the water, as mentioned, such that the structure of the heating device is also simpler compared to heating by means of gas.

### BRIEF DESCRIPTION OF THE DRAWINGS

For a more detailed explanation of the invention, an exemplary embodiment thereof will be described in greater detail hereinafter on the basis of the drawing, in which:

FIG. 1 shows a schematic diagram as a cross-sectional view of a first embodiment of a device according to the invention for the catalytic depolymerization of material containing hydrocarbon with use of an induction device,

FIG. 2 shows a schematic view of a container with heating according to the invention with use of an induction device, and

FIG. 3 shows a schematic diagram of a container with heating according to the invention with use of an induction device, wherein a perforated sheet device is arranged around the induction device.

### DETAILED DESCRIPTION OF THE INVENTION

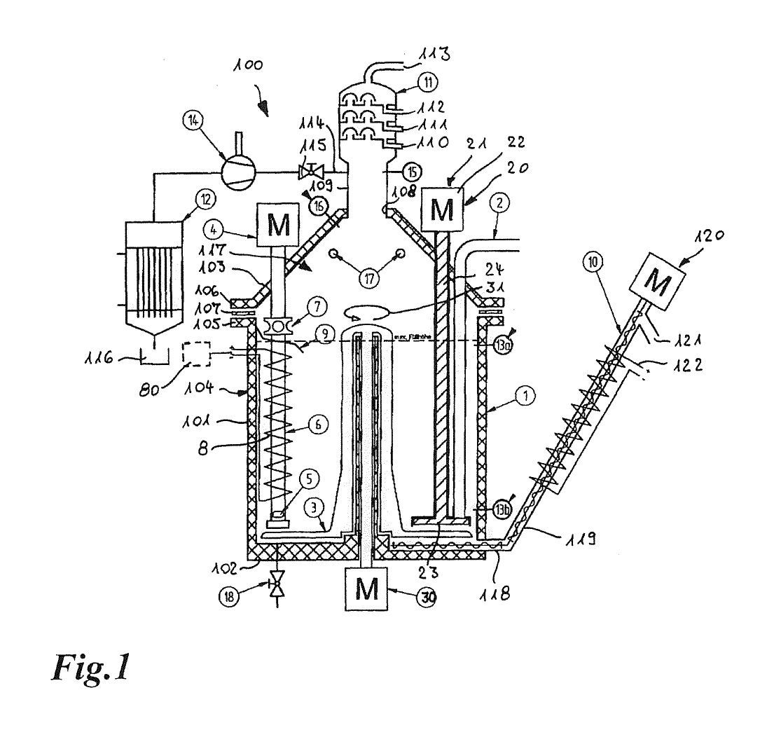

FIG. 1 shows an embodiment of a device 100 for catalytic depolymerization, containing a container 1, in which most of the components of the device 100 are arranged. The device is thus structured in a very compact manner compared to known devices and can be protected well against heat losses. This occurs in the case of the container 1 shown in FIG. 1 in that said container is insulated in the region of the outer wall 101 thereof, floor wall 102 and cover 103 thereof, and in particular has an outer insulation layer. The cover 103 of the container 1 is funnel-shaped and can be connected to the rest of the container body 104 via connection means known per se. The connection is produced in the example shown in FIG. 1 in the region of flanges 105, 106 of the cover 103 and of the container body 104, wherein at least one sealing element 107 can be provided in this region in order to seal the container interior with respect to the surrounding environment.

In the upper region thereof, the funnel-shaped cover 103 has a central or middle opening 108. This is adjoined by a connection pipe 109, which ends in a column 11, here a high-performance bubble tray column. This has three lateral outlet openings 110, 111, 112 at the height of the respective bubble trays and also an upper outlet opening 113. A line 114 with a suction device 14 is also connected to the connection pipe 109 in the region between the opening 108 and the column 11, below said column, and can be locked via a valve 115. The suction device 14, here a vacuum suction system, is connected to a cooling device 12, here in the form of a tube bundle cooler, for condensing water vapor. A condensed water container 116 is provided in order to collect the condensed water produced.

A temperature sensor 15 is also arranged on the connection pipe 109, for example at the branch of the line 114. This temperature sensor is used, as will also be described further below, to check the temperature of the rising vapor so as to close the valve 115 when a predetermined temperature of the vapor is exceeded and to therefore prevent the vapor from being suctioned into the line 114, but to allow said vapor to flow through the column 11.

Further openings 17 are also provided in the cover 103 of the container and are used to inject gases, in particular carbon dioxide, so as to be able to selectively conduct reactions of at least individual components of the forming vapor with the gas before the vapor rises further and these components exit from the container or contaminate the distillation products, which can be removed at the outlet openings 110, 111, 112 of the column 11. In order to detect rising vapor, a gas detector 16 protrudes into the interior of the upper region of the container.

Further components of the device 100 also protrude through the cover 103 of the container 1, inter alia the end of a filling pipe 2 and a drive 21 of an agitator 20. This drive 21 comprises a motor 22 and a drive shaft 24 extending approximately perpendicularly to a comminution unit 23 of the agitator 20. The drive shaft 24 and the filling pipe 2 extend in this exemplary embodiment adjacently and approximately parallel to one another, wherein the filling pipe 1 ends approximately at the height of the comminution unit 23 of the agitator, such that material, such as a wide range of types of residual materials, for example plastics, waste oil, cellulose, sewage sludge, etc., can be subsequently comminuted before they pass into the interior of the container. The addition of material and size thereof can be controlled via the outlet opening.

A carrier medium, such as waste oil with a proportion of high-temperature oil, in particular 20% high-temperature oil, so as to be able to tolerate well the high temperatures prevailing, is introduced into the container 1 prior to the introduction of the material to be catalytically depolymerized. This will be discussed in greater detail further below as part of the description of the method for catalytic depolymerization. The filling levels of the carrier medium with or possibly also without material to be depolymerized can be monitored by fill-level sensors 13a, 13b. The fill-level sensor 13a is used to check a possible overshoot of the maximum filling height, whereas the fill-level sensor 13b is used to check an undershoot of the minimum fill-level height.

A further device extending through the cover 103 of the container 1 is a conveyor device 6 or drive unit 4 thereof. This conveyor device 6 is used to suction material from the lower region of the container 1, to convey the material upwardly and to heat the material during this process so as to evaporate said material. At least one intake opening 5 is provided in the lower region of the conveying device 6 in order to suction the material, and at least one outlet opening 7 or an outlet ring with one or more openings is provided in the upper region of the conveyor device 6 in order to discharge material. A baffle or run-off plate 9 is provided below the outlet ring or the outlet opening(s) 7, possibly an HF cyclone. The heated material, after exiting from the outlet opening or the outlet ring, contacts the baffle or run-off plate 9 and runs hereover particularly well and selectively back into the carrier medium. A device for introducing heat, provided here in the form of an inductor 8, such as a medium-frequency inductor, which is connected to a medium-frequency generator 80, is provided externally on the conveyor device 6 for heating. Paddle wheels are provided within the conveyor pipe of the conveyor device and are each provided with a movable part, which bears against the inner face of the conveyor pipe during rotation on account of centrifugal force. The inner face of the conveyor pipe can thus be cleaned constantly. The conveyor device may comprise, for example, a turbine with an MF-HF generator as drive.

A drain valve 18 is also provided in the floor wall 102 of the container in order in particular to be able to remove carrier medium or liquid components from the container when the maximum filling level is exceeded.

To avoid a settling of solids, a floor scraper 3 is provided in the lower region of the container 1. This scraper is connected to a drive unit 30. The floor scraper 3 can thus be driven in rotation, which is indicated by the arrow 31 in FIG. 1.

A further conveyor device in the form of a screw conveyor 10 for transporting away solids from the lower region of the container is arranged in a region beneath the floor scraper 3 and extends approximately parallel to the floor wall 102 of the container via a first part 118. A second part 119 arranged outside the container extends obliquely, that is to say at an angle, from the container floor upwardly. In the upper end region, a drive unit 120 for driving the conveyor device 10 is arranged at the end. An outlet opening 121 is also provided in this end region of the conveyor device, through which outlet opening the solids can be removed. In order to dry the solids, a device for introducing heat 122 is provided along the obliquely arranged part 119 of the conveyor device.

In the case of the method for the catalytic depolymerization of materials or residual materials, the container is first filled with a carrier medium, such as the aforementioned waste oil with a proportion of, for example, 20% high-temperature oil. By way of example, the container is filled with a quantity of 1,500 l of carrier medium. An undershoot of the minimum filling height and an overshoot of the maximum filling height can be monitored by means of the fill-level sensors 13a, 13b. In a first step, the solid and/or liquid materials or residual materials are then introduced into the device through the filling pipe 2. The comminution unit 23, in particular in the form of a disc, arranged at the lower end of the agitator 20 can ensure a post-comminution of the material. By way of example a small housing gap is provided here, through which the material can enter the container interior and from here into the carrier medium. It is thus ensured that the material introduced newly into the container always enters the liquid region and vapor cannot pass undesirably from the vapor zone 117 arranged in the cover 103 of the container to the outside as the material is filled.

The post-comminuted mass exiting laterally at the agitator 20 is set in a rotary motion by said agitator together with the carrier medium, such that the carrier medium and the mass mix together at least in the region of the container 1 close to the floor. In addition, the floor scraper 3 driven by means of the drive unit 30, for example a gear motor, can produce a rotary movement of the carrier medium with material so as to mix these two substances.

The lower end of the conveyor device 6 or tubular turbine is arranged for example at a distance of approximately 100 mm from the floor wall 102. Via the intake opening 5 arranged in this lower region of the conveyor device 6, the material mixed with the carrier medium is sucked into the interior of the conveyor device. The conveyor paddles or paddle wheels arranged in the conveyor device 6 are set in a rotary motion by the drive unit 4 or drive shaft thereof and convey the suctioned material mixture in the conveyor device upwardly. As already mentioned, the conveyor paddles or the paddle wheels are provided with movable depositors or elements, which bear against the inner face of the pipe wall of the conveyor device 6 during the rotary motion on account of the centrifugal forces acting on said depositors or elements and thus prevent an adhesion of material there. The conveyor device 6 is hereby formed in a self-cleaning manner.

The material mixture conveyed upwardly over the length of the conveyor device 6 exits again at the upper end through the at least one outlet opening 7 or the outlet ring and passes back into the carrier medium. The material is heated over the conveyor path by the device 8 for introducing heat or by the inductor 8. This process, that is to say the circulation of the material, is repeated until the material has been brought to evaporation temperature. Due to the use of the inductor 8 or induction heater in conjunction with the medium-frequency generator 80, a high degree of efficacy can be obtained. The energy required to cool the inductor can be recovered here by means of a heat exchanger, and the heat produced during this process can be used to pre-heat the material or residual material.

The vapor of the evaporating material enters the vapor zone 117 of the container 1. This is merely water vapor in the first stage of the vapor phase. This is sucked into the cooling device 12 or the tube bundle cooler by opening the valve 115 and actuating the suction device 14 and is condensed there. The distilled water produced during this process is collected in the condensed water container 116. Water vapor is produced at temperatures of vapor from approximately 100° C. to approximately 105° C. From this temperature, the valve 115 can be closed again. The temperature is measured via the temperature sensor 15.

With vapor temperatures of more than 300° C., the desired distillation products can be separated in the column 11. Heavy distillate, such as oil, therefore collects on the first bubble tray, medium-weight distillate, such as diesel, collects on the second bubble tray, and light distillate, such as petrol, collects on the uppermost bubble tray. Accordingly, petrol can be removed through the outlet opening 112, diesel can be removed through the outlet opening 111, and oil can be removed through the outlet opening 110.

To increase the degree of efficacy of the device, the material mixture together with the added catalyst can be pumped at temperatures of, for example, approximately 100-130° C. through the drain valve 18 into a special pressure container. The material mixture can remain in the pressure container for approximately 30 min under a pressure of 30 bar. The material mixture is then pumped back into the container 1. This measure can be performed optionally, depending on the composition of the feedstock, in order to provide a quicker and more efficient mixing of the input components with the catalyst, a greater yield of the at least one finished product, and a lower proportion of residual materials.

The solids settling on the floor are detached from the floor by the floor scraper 3 and, provided they do not mix with the carrier medium, are fed to the screw conveyor 10. This serves as a solids separator, wherein the first part 118 of the screw conveyor is arranged in a groove in the container floor or the floor wall 102. The solids are conveyed in the direction of the second, obliquely extending part 119 of the screw conveyor 10. Here, liquid components flow downwardly again, back into the container. The remaining solids part, also referred to as oil cake, is heated by means of the device 122 for heat introduction, such that dry residual material or solid material can be removed at the end of the screw conveyor 10 through the outlet opening 121. Until this removal, all solids remain in the container, that is to say are not normally removed therefrom in another way.

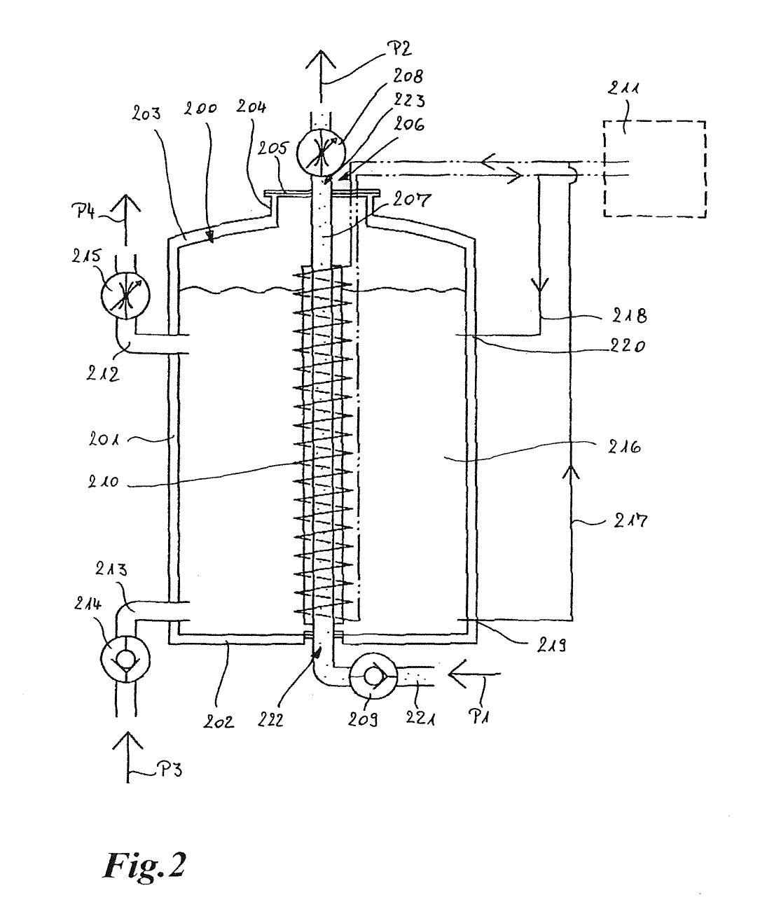

FIG. 2 shows a schematic diagram of an isolated container 200, which has a lateral wall 201. The container 200 first has a floor wall 202 and an upper cover wall 203. The cover wall comprises a cover connection piece 204, which is arranged in the middle or centrally and which is closed by a flange or fastening flange 205. An outlet-side end portion 206 of a heating pipe 207 is guided in the fastening flange 205 or therethrough and has an outlet opening 223. A throttle valve 208 is arranged in the heating pipe 207 outside the container, and therefore also outside the fastening flange 205. The heating pipe 207 is also guided through the floor wall 202 of the container 200, and there has an inlet opening 222. The heating pipe 207 is provided with a check valve 209 outside the container 200. Surface water is conveyed through the heating pipe 207 and enters the heating pipe 207 via the inlet opening 222 and exits therefrom again through the outlet opening 223, wherein service water supply and discharge are indicated in FIG. 2 by the arrows P1 and P2. The check valve 209 prevents an undesirable return flow into the service water feed line network, and the flow rate through the heating pipe 207, and therefore indirectly also the residence time therein, can be controlled or regulated via the throttle valve 208.

The heating pipe 207 is surrounded externally by a device for introducing heat in the form of an inductor 210. The inductor 210 is connected to a medium-frequency generator 211, which is arranged outside the container 200, as also indicated in FIG. 2.

The container 200 further comprises two heating circuit connections 212, 213, wherein the heating circuit connection 212 is connected or will be connected to a heating circuit feed and the heating circuit connection 213 is connected or will be connected to a heating circuit return, and wherein the heating circuit connection 213, which is connected to the return, is arranged in the lower portion of the container 200 in the vicinity of the floor wall 202, and the heating circuit connection 212, which is connected to the feed, is arranged in the upper region of the container, that is to say in the upper half of the container 200. A check valve 214 is arranged in the region of the heating circuit connection 213, and a throttle valve 215 is arranged in the region of the heating circuit connection 212. The direction of flow of the medium flowing through the heating circuit, said medium being water 216 in particular, is indicated by the arrows P3 and P4. It passes downwardly into the container 200 at the heating circuit connection 213, flows upwardly through this container and out again therefrom in the upper region of the container through the heating circuit connection 212. Accordingly, the medium, in particular water 216, is received within the container 200 so as to surround the heating pipe 207 with external inductor 210.

The water 216 or medium is also used to cool the inductor 216, wherein water 216 is removed from the lower region of the container, that is to say the region above the floor wall 202 of the container 200, by means of an inductor cooling feed 217, and the heated water 216 used to cool the inductor 210 is fed back again into the upper region, that is to say the upper half, of the container 200 via an inductor cooling return 218. This is also indicated in FIG. 2. Respective connections 219, 220 are provided to remove and to return the water 216 or medium located in the container 200 and are connected to the inductor cooling feed 217 and the inductor cooling return 218, as also indicated in FIG. 2.

In order to heat the water 216 contained in the container 200, wherein the container is closed in so far as no further opening in or from the container is provided apart from the openings for the passage of the heating pipe 207 and the feed lines of the inductor 210 and also of the connections 212, 213, 219, 220 as mentioned above, service water 221 is conveyed through the heating pipe 207 and in doing so heats up as a result of the action of the heat energy introduced by the inductor 210. Service water for example for consumption in a household can be heated as a result instead of the use of otherwise conventional gas heating. The container 200 can be formed for example as a steel container, wherein the holding capacity thereof and accordingly the dimensions thereof can be adapted to the respective application. The service water 221 is heated as is passes through the heating pipe 207 provided externally with the inductor 210. The service water 221 flows in as fresh service water at the lower end of the heating pipe 207 through the inlet opening 222 provided there or flows previously through the check valve 209 (arrow P1). When rising in the heating pipe 207, that is to say when flowing through said heating pipe, the service water is heated by means of the induction energy provided by the inductor in conjunction with the medium-frequency generator 211. The exit from the heating pipe 207 is implemented through the outlet opening 223 and the throttle valve 208 (arrow P2). The inductor 210 extends over practically the entire length of the heating pipe, such that a heating of the service water 221 flowing there through the heating pipe is possible over this length as a heating section.

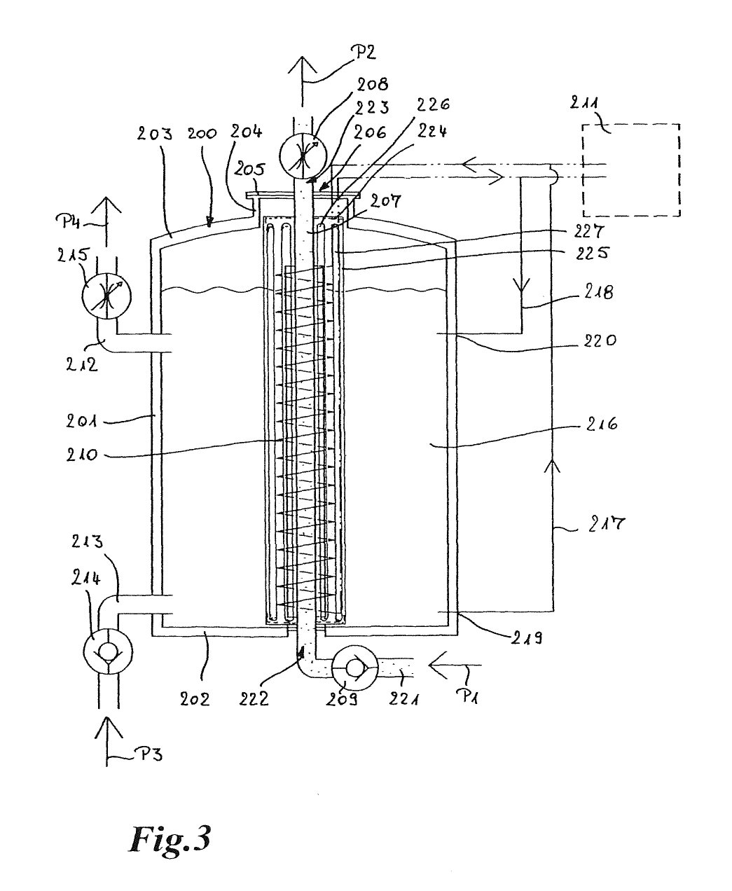

As shown in FIG. 3, a closable perforated sheet device, in particular in the form of two pipes 224, 225 arranged one inside the other with openings 226, 227 or slits provided in the lateral surface thereof, can be provided around the inductor 210 so as to enable an even more effective utilization of the heat energy provided by the inductor. The inner pipe 224 is referred to as a stator pipe and the outer pipe 225 is referred to as a rotor pipe, wherein both are provided with openings or slits. In FIG. 3, the outer pipe 225 can be seen primarily, and the inner or stator pipe 224 is arranged with the openings 226 thereof aligned beneath the openings 227 in the outer or rotor pipe 225. By turning the rotor pipe 225 with respect to the stator pipe 224, the slits or openings 226, 227 can be closed. Following the closure of the slits or openings 226, 227 provided in both pipes, the maximum heating capacity can be introduced into the service water 221. With opened openings 226, 227 or slits, the heat transfer into the service water flowing through the heating pipe 207 can be shut off, and the complete heat energy provided by the inductor 210 can be transferred into the heating water circuit, that is to say into the water 216, which surrounds the heating pipe 207 and also the other two tubes 224, 225.

As already mentioned, the cooling of the inductor follows by removal of water 216 from the container 200 via the connection 219 into the inductor cooling feed 217. The water 216 returned after the cooling of the inductor via the inductor cooling return 218 passes again via the connection 220 into the interior of the container 200. The cooling capacity is thus supplied directly to the inductor 210 by the water 216, wherein there is no need to provide any additional cooling devices or cooling media.

With such a device for heating service water 221 in the form of the container provided with the various above-mentioned components, a very compact device for heating service water can be created on the one hand, and on the other hand a very high degree of efficacy of more than 95% can be attained. Furthermore, there are no exhaust gases, which are otherwise unavoidable when heating service water via gas heating.

Besides the embodiments of devices and methods described above and shown in the drawing for the catalytic depolymerization of material containing hydrocarbon and devices for heating media, numerous further devices and methods can also be formed, with which at least one conveyor device having a device for introducing heat into the interior of the conveyor device and having at least one inlet opening and at least one outlet opening spaced apart therefrom is provided in the container, wherein the inlet opening is or can be disposed in the lower region of the container and the outlet opening is or can be disposed in the upper region of the container in order to circulate and heat the material to evaporation temperature.

### REFERENCE LIST

1 container
2 filling pipe
3 floor scraper
4 drive unit
5 intake opening
6 conveyor device
7 outlet opening/outlet ring
8 inductor/device for introducing heat
9 baffle or run-off plate
10 conveyor device/screw conveyor
11 column
12 cooling device
13a first fill-level sensor for maximum filling height
13b second fill-level sensor for minimum filling height
14 suction device
15 temperature sensor
16 gas detector
17 opening
18 drain valve
20 agitator
21 drive
22 motor
23 comminution unit
24 drive shaft
30 drive unit
31 arrow
80 medium-frequency generator
100 device
101 outer wall
102 floor wall
103 cover
104 container body
105 flange
106 flange
107 sealing element
108 middle opening
109 connection pipe
110 first outlet opening
111 second outlet opening
112 third outlet opening
113 upper outlet opening
114 line
115 valve
116 condensed water container
117 vapor zone
118 first part of 10 running parallel to the floor of the container
119 obliquely extending second part of 10
120 drive unit
121 discharge opening
122 device for introducing heat
200 container
201 insulated lateral wall
202 floor wall
203 cover wall
204 cover connection piece
205 fastening flange
206 end portion
207 heating pipe
208 throttle valve
209 check valve
210 inductor
211 medium-frequency generator
212 heating circuit connection (feed)
213 heating circuit connection (return)
214 check valve
215 throttle valve
216 water/heating medium
217 inductor cooling feed
218 inductor cooling return
219 connection
220 connection
221 service water
222 inlet opening
223 outlet opening
224 inner pipe/stator pipe
225 outer pipe/rotor pipe
226 opening/slit in 224
227 opening/slit in 225
P1 arrow
P2 arrow
P3 arrow
P4 arrow

What is claimed is:

1. A device for catalytic depolymerization of material containing hydrocarbon, comprising: at least one container which can be filled with the material,
wherein at least one conveyer device having a device for introducing heat into an interior of the conveyor device and having at least one inlet opening and at least one outlet opening spaced apart therefrom are provided in the container, wherein the inlet opening is or can be disposed in a lower region of the container and the outlet opening is or can be disposed in an upper region of the container for circulating and heating the material to evaporation temperature.

2. The device according to claim 1, wherein the device for introducing heat is a device working on the basis of induction, and in particular comprises a medium-frequency inductor.

3. The device according to claim 1, wherein the conveyor device comprises conveyor elements for conveying the material from the at least one inlet opening to the at least one outlet opening and elements which bear against an inner face of a wall of the conveyor device as a result of an effect of centrifugal force.

4. The device according to claim 3, wherein the conveyor elements are paddle wheels, which are provided with at least one movable depositor made of cast material.

5. The device according to claim 1, wherein the container tapers in a funnel-shaped manner in the upper region.

6. The device according to claim 1, wherein the container is a high-temperature container provided with at least one heat-insulating insulation layer.

7. The device according to claim 1, wherein at least one column for condensing and removing distillate of different specific weight is provided in the upper region of the container or is connected thereto.

8. The device according to claim 1, wherein at least one conveyor device, having at least one device for solids drying is provided, and an inlet opening of the conveyor device is arranged in the lower region of the container.

9. The device according to claim 1, wherein at least one device for preventing material from settling on a floor of the container is provided.

10. A method for catalytic depolymerization of material containing hydrocarbon using at least one container which can be filled with the material, comprising the steps of:
filling at least one carrier medium is filled into the container,
introducing the material into the carrier medium,
setting the carrier medium comprising the material in a rotary motion,
circulating the material through a conveyor device having a device for introducing heat and heating until said material is brought to evaporation temperature,
condensing the rising vapor and
discharging the distillate components as products.

11. The method according to claim 10, wherein the material in the conveyor device is heated by an induction heater, wherein the energy for cooling the induction heater with use of a heat exchanger is used to pre-heat the material.

12. The method according to claim 10, wherein the material mixture, in particular plus an added catalyst, is conveyed into a pressure container at temperatures of approximately 100° C. or above, remains there in the pressure container for a predeterminable period of time, under a predefinable pressure, and is then conveyed back into the container.

13. The method according to claim 10, wherein solids from a floor region of the container are removed from the floor region of the container via a conveying device arranged obliquely with respect to the container, liquid components flow back into the container, and a remaining oil cake is heated and removed from the conveying device.

14. The method according to claim 10, wherein at least one additive, for binding undesired depolymerization products is introduced into the carrier medium/material mixture.

15. A device for heating a medium to be depolymerized and/or water,
wherein the device is a device working on a basis of induction.

16. The device according to claim 15, wherein the device comprises a medium-frequency generator.

17. The device according to claim 8, wherein the conveyor device is a screw conveyor.

18. The device according to claim 9, wherein the device for preventing material from setting is a rotatable device formed as a floor scraper.

19. The method according to claim 12, wherein the temperature is 100° C. to 130° C., wherein the period of time is 30 min, and wherein the pressure is 30 bar.

20. The method according to claim 14, wherein the at least one additive is a catalyst material, and wherein the depolymerization products are halogens and furans.
